(19) United States
(12) Patent Application Publication
(10) Pub. No.: US 2012/0320623 A1
(43) Pub. Date: Dec. 20, 2012

(54) ILLUMINATING DEVICE AND DISPLAY DEVICE

(75) Inventor: Takeshi Wada, Osaka-shi (JP)

(73) Assignee: SHARP KABUSHIKI KAISHA, Osaka-shi, Osaka (JP)

(21) Appl. No.: 13/581,381

(22) PCT Filed: Mar. 1, 2011
(86) PCT No.: PCT/JP2011/054619

§ 371 Date: Aug. 27, 2012

(30) Foreign Application Priority Data
Apr. 15, 2010 (JP) 2010-093884

(51) Int. Cl. F21V 8/00

(52) U.S. Cl. 362/602; 362/611; 362/612

(57) ABSTRACT

An illuminating device includes a light guide plate; a light source that is located opposite at least two adjacent end faces of four end faces of the light guide plate; and a chassis that has an opening through which light emanating from a light emission surface of the light guide plate passes. At least one optical sheet that includes a corner portion with an interior angle of greater than 90 degrees in a position corresponding to a corner portion of the light guide plate that is sandwiched between the two end faces opposite the light source is disposed between the light emission surface of the light guide plate and the chassis.

### RELATED APPLICATIONS

The present application is a National Phase of International Application Number PCT/JP2011/054619, filed Mar. 1, 2011, and claims priority from Japanese Application Number 2010-093884, filed Apr. 15, 2010.

### TECHNICAL FIELD

The present invention relates to an illuminating device, particularly an illuminating device including a light guide plate. The present invention also relates to a display device including the illuminating device.

### BACKGROUND ART

In a liquid crystal display device, e.g., an illuminating device (backlight device) is located on the back of a liquid crystal panel, and a user observes light that has been emitted from the illuminating device and passed through the liquid crystal panel.

The above illuminating device is broadly divided into a direct type and an edge-light type depending on the arrangement of a light source with respect to the liquid crystal panel. The edge-light type can reduce the thickness more easily than the direct type, and therefore is generally used for mobile equipment such as a portable telephone, a notebook computer, a PDA, etc.

In the edge-light type, a light source is located opposite the end faces around a light guide plate having a substantially rectangular light emission surface. The light emitted from the light source enters the end faces of the light guide plate, emanates from the light emission surface, which is one of a pair of principal surfaces of the light guide plate, and illuminates the liquid crystal panel.

Patent Document 1 discloses an illuminating device in which a cold-cathode fluorescent tube (light source) is arranged into a substantially U-shape so that the cold-cathode fluorescent tube faces three end faces of the four end faces of a substantially rectangular light guide plate. Patent Document 2 discloses an illuminating device in which a cold-cathode fluorescent tube (light source) is arranged into a substantially L-shape so that the cold-cathode fluorescent tube faces two adjacent end faces of the four end faces of a substantially rectangular light guide plate.

### PRIOR ART DOCUMENTS

### Patent Documents

Patent Document 1: JPH8(1996)-36178 A

Patent Document 2: JP 2005-222862 A

### DISCLOSURE OF INVENTION

### Problem to be Solved by the Invention

In recent years, an LED (light emitting diode) has been increasingly used as a light source. In this case, a plurality of LEDs are arranged at about the same pitch with respect to one end face of the light guide plate. The LEDs generate heat during emission. If the LEDs are arranged into a substantially U-shape or a substantially L-shape along the end faces of the light guide plate, as described above, it is likely that the temperature of a corner portion that is sandwiched between two adjacent end faces opposite the LEDs is particularly high, since the density of the arrangement of the LEDs is high. On the other hand, a temperature rise is relatively small in the end face where no light source is located. Therefore, there is a temperature difference in the light guide plate or its peripheral members when viewed from the direction of the normal to the light emission surface.

In general, in the illuminating device for a liquid crystal panel, an optical sheet can be placed between the light guide plate and the liquid crystal panel to provide uniform brightness or the like. The linear expansion coefficient of the optical sheet is generally larger than that of the light guide plate. Accordingly, the thermal expansion of the optical sheet is increased in the corner portion at higher temperatures, and the edge of the optical sheet collides with the peripheral member, so that the optical sheet is curved in a wavelike fashion. Consequently, the brightness distribution of the illuminating device is not uniform, and the display quality of the liquid crystal display device is reduced due to display unevenness.

It is an object of the present invention to solve the above conventional problems and to prevent the optical sheet from colliding with the peripheral member and being curved in a wavelike fashion even if the corner portion of the optical sheet is thermally expanded by heat of the light source.

### Means for Solving Problem

An illuminating device of the present invention includes the following: a light guide plate that includes a substantially rectangular light emission surface and four end faces adjacent to the light emission surface; a light source that is located opposite at least two adjacent end faces of the four end faces of the light guide plate; and a chassis that has an opening through which light emanating from the light emission surface of the light guide plate passes. At least one optical sheet that includes a corner portion with an interior angle of greater than 90 degrees in a position corresponding to a corner portion of the light guide plate that is sandwiched between the two end faces opposite the light source is disposed between the light emission surface and the chassis.

A display device of the present invention includes the illuminating device of the present invention.

### Effects of the Invention

In the present invention, the optical sheet includes the corner portion with an interior angle of greater than 90 degrees. The optical sheet is disposed so that this corner portion corresponds to the corner portion of the light guide plate that is sandwiched between two end faces opposite the light source. Therefore, even if the temperature is much higher in the corner portion than in the other portions of the optical sheet, the present invention can reduce the possibility that the edge of the corner portion of the optical sheet will collide with the peripheral member. Thus, the present invention can reduce the possibility that the optical sheet will be curved in a wavelike fashion due to the collision with the peripheral member.

### BRIEF DESCRIPTION OF DRAWINGS

FIG. 1 is an exploded perspective view showing a schematic configuration of a liquid crystal display device according to Embodiment 1 of the present invention.

FIG. 2A is a cross-sectional view of one short side in the thickness direction of the liquid crystal display device shown in FIG. 1. FIG. 2B is a cross-sectional view of the other short side in the thickness direction of the liquid crystal display device shown in FIG. 1.

FIG. 3A is a plan view showing measurement positions of a surface temperature of a liquid crystal panel of a liquid crystal display device according to Embodiment 1 of the present invention. FIG. 3B shows the measurement results of the surface temperature of the liquid crystal panel at each of the measurement positions shown in FIG. 3A.

FIG. 4 is a plan view showing the shape of an optical sheet used in an illuminating device according to Embodiment 1 of the present invention.

FIG. 5 is a plan view showing the shape of an optical sheet used in an illuminating device according to Embodiment 2 of the present invention.

### DESCRIPTION OF THE INVENTION

As described above, the optical sheet is heated by heat generated from the light source during the operation of the illuminating device. The temperature rise is particularly large in the corner portion that is sandwiched between two adjacent sides where the light source is located. In the present invention, considering a difference in thermal expansion caused by the temperature difference of the optical sheet, the outer dimensions of the optical sheet are set to be small beforehand. That is, the two adjacent sides where the light source is located are reduced in length in view of the difference in thermal expansion from the side where no light source is located. Thus, the interior angle of the corner portion that is sandwiched between those two sides is greater than 90 degrees. Therefore, even if the temperature of the corner portion is locally increased so that the corner portion is thermally expanded outward significantly, the corner portion can be prevented from colliding with the peripheral member.

In the illuminating device of the present invention, the number of optical sheets to be provided between the light emission surface of the light guide plate and the chassis may be either one or more than one. If a plurality of optical sheets are provided, at least one of the optical sheets may include the corner portion with an interior angle of greater than 90 degrees.

In particular, it is preferable that the optical sheet having a linear expansion coefficient of 7×10⁻⁵/K or more, and further 9×10⁻⁵/K or more includes the corner portion with an interior angle of greater than 90 degrees. This is because it is highly probable that the optical sheet having a large linear expansion coefficient collides with the peripheral member due to the thermal expansion.

The light source is not particularly limited, but is preferably an LED. This is because the LED generates heat during emission, and thus the effects of the present invention can be prominent.

The arrangement of the light source is not particularly limited. For example, the light source may be located opposite three end faces of the light guide plate or two adjacent end faces of the light guide plate.

Hereinafter, the present invention will be described in detail by way of preferred embodiments. It should be noted that the present invention is not limited to the following embodiments. For convenience of explanation, each of the drawings that are to be referred to in the following description schematically shows only the main members required to describe the present invention, among the constituent members of the embodiments of the present invention. Therefore, the present invention can include any constituent members that are not shown in the following drawings. The size of and size ratio of each of the members in the following drawings do not exactly reflect those of the actual constituent members.

### Embodiment 1

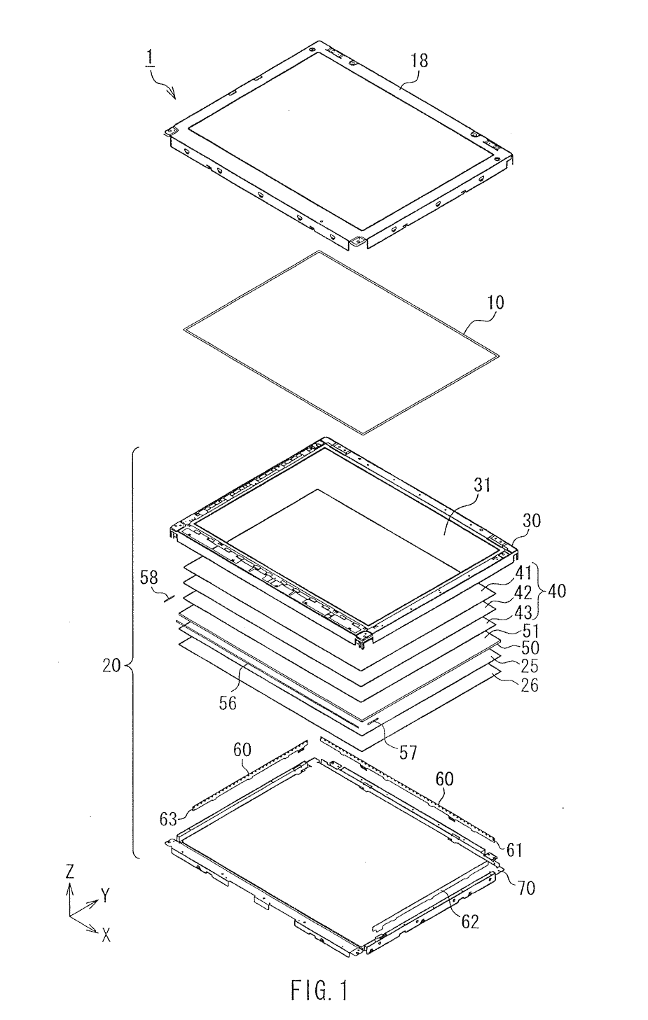

FIG. 1 is an exploded perspective view showing a schematic configuration of a liquid crystal display device 1 according Embodiment 1 of the present invention. For convenience of explanation, the axis parallel to the thickness direction of the liquid crystal display device 1 (i.e., the vertical direction of the sheet of FIG. 1) is defined as a Z axis. The axis perpendicular to the Z axis and parallel to the long side of a display surface is defined as an X axis. The axis perpendicular to the Z axis and parallel to the short side of the display surface is defined as a Y axis.

The liquid crystal display device 1 includes a transmission type liquid crystal panel 10 that serves as a display portion, and an edge-light type illuminating device 20 that is located on the back of the liquid crystal panel 10 and illuminates the liquid crystal panel 10.

The liquid crystal panel 10 includes an active substrate on which many pixel electrodes are arranged in a matrix, a counter substrate on which transparent electrodes are formed so as to face the many pixel electrodes of the active substrate, and a liquid crystal sealed between the two substrates. The potential of each of the many pixel electrodes is controlled so that the passage of illumination light from the illuminating device 20 is controlled pixel by pixel. The liquid crystal panel 10 is fixed to the illuminating device 20 by a bezel 18 in the form of a rectangular frame. The bezel 18 can be produced, e.g., by press molding of a metal plate.

The illuminating device 20 includes, from the liquid crystal panel 10 side, a chassis 30, an optical sheet 40, a light guide plate 50, reflecting sheets 25, 26, and a back plate 70 in this order along the Z axis. The illuminating device 20 further includes LED substrates 61, 62, 63, on each of which a plurality of LEDs 60 are mounted as light sources.

The light guide plate 50 is a plate-like body made of a synthetic resin such as a transparent acrylic resin (e.g., PMMA). The light guide plate 50 includes a pair of principal surfaces that are substantially rectangular in shape and face each other. One of the pair of principal surfaces that faces the liquid crystal panel 10 is a light emission surface 51. The pair of principal surfaces of the light guide plate 50 are connected with four end faces around the light guide plate 50. Among the four end faces, the end faces parallel to the X axis are called “long-side end faces”, and the end faces parallel to the Y axis are called “short-side end faces”.

In each of the LED substrates 61, 62, 63, the LEDs 60 are arranged at about the same pitch in the longitudinal direction of each of the substrates 61, 62, 63. The LED substrate 61 is located parallel to the X axis, and light emitted from the plurality of LEDs 60 mounted on the LED substrate 61 enters one of a pair of long-side end faces of the light guide plate 50. The LED substrates 62, 63 are located parallel to the Y axis, and light emitted from the plurality of LEDs 60 mounted on the LED substrate 62 enters one of a pair of short-side end faces of the light guide plate 50, while light emitted from the plurality of LEDs 60 mounted on the LED substrate 63 enters the other of the pair of short-side end faces of the light guide plate 50. The light that has entered from the three end faces of the light guide plate 50 is diffused while being totally reflected in the light guide plate 50 and thus propagates. The diffused light emanates from the light emission surface 51 that faces the liquid crystal panel 10.

Edge tapes 56, 57, 58 are attached to the areas of the four end faces of the liquid guide plate 50 that are not opposite the LED substrates 61, 62, 63. The edge tapes 56, 57, 58 allows the light that has leaked from the end faces of the light guide plate 50 to the outside to reenter the light guide plate 50, thereby achieving the effective utilization of light. However, a part or the whole of the edge tapes 56, 57, 58 may be omitted.

The optical sheet 40 of this embodiment includes three sheets, i.e., a brightness enhancement sheet 41, a lens sheet 42, and a diffusion sheet 43 from the liquid crystal panel 10 side.

The brightness enhancement sheet 41 includes a reflection type polarizing film that selectively transmits only the P wave of light emanating from the light emission surface 51 of the light guide plate 50 and reflects the S wave of this light toward the light guide plate 50, so that the light utilization efficiency is improved. In order to improve the thermal stability, light diffusion films may be formed on both sides of the reflection type polarizing film. Although the material of the brightness enhancement sheet 41 is not particularly limited, the reflection type polarizing film can be made of, e.g., polyester and the light diffusion films can be made of, e.g., polycarbonate. In this case, the linear expansion coefficient of the brightness enhancement sheet 41 is about 9×10⁻⁵/K.

The lens sheet 42 has a fine prism pattern formed on the surface that faces the liquid crystal panel 10, and improves the brightness in the front direction. The material of the lens sheet 42 is not particularly limited and can be made of, e.g., polyester. In this case, the linear expansion coefficient of the lens sheet 42 is about 3×10⁻⁵/K.

The diffusion sheet 43 has fine irregularities or the like formed on one side, and diffuses light passing through it. The material of the diffusion sheet 43 is not particularly limited and can be made of, e.g., polyester. In this case, the linear expansion coefficient of the diffusion sheet 43 is about 3×10⁻⁵/K.

The above configuration of the optical sheet 40 is merely an example, and the optical sheet of the present invention is not limited to the above example as long as it includes at least one sheet. For example, one or two of the sheets 41, 42, 43 may be omitted, and two or three of the sheets 41, 42, 43 may be replaced by a single sheet having the functions of those sheets. Another sheet having the function other than those described above may be further added.

The thickness of one optical sheet 40 is not particularly limited, but preferably 0.15 mm or more, and more preferably 0.20 mm or more. If the thickness of the optical sheet 40 is reduced, the optical sheet 40 is likely to be distorted and deformed, which can lead to a problem such as a non-uniform brightness distribution of the illuminating device 20.

The reflecting sheets 25, 26 face the principal surface of the light guide plate 50 that is on the opposite side of the light emission surface 51, and allows the light that has leaked from the light guide plate 50 to reenter the light guide plate 50, thereby achieving the effective utilization of light. In this embodiment, two reflecting sheets 25, 26 are used to improve the brightness of the illuminating device 20. However, only one reflecting sheet may be used. Alternatively, three or more reflecting sheets may be used, e.g., to improve the brightness further.

The back plate 70 can be produced, e.g., by bending and forming a metal plate into a predetermined shape by press molding or the like. In order to hold the reflecting sheets 25, 26, the light guide plate 50, the brightness enhancement sheet 41, the lens sheet 42, and the diffusion sheet 43 in their predetermined positions in the X axis direction and the Y axis direction with respect to the back plate 70, pins (not shown) that are to be inserted through or engaged with these members for positioning may be provided parallel to the Z axis in the vicinity of the long side of the back plate 70 that is opposite the long side where the LED substrate 61 is located.

The chassis 30 is a rectangular frame body having an opening 31 in the center, through which light emanating from the light emission surface 51 of the light guide plate 50 passes. The chassis 30 can be produced, e.g., by integrally forming a synthetic resin material such as polycarbonate by injection molding or the like.

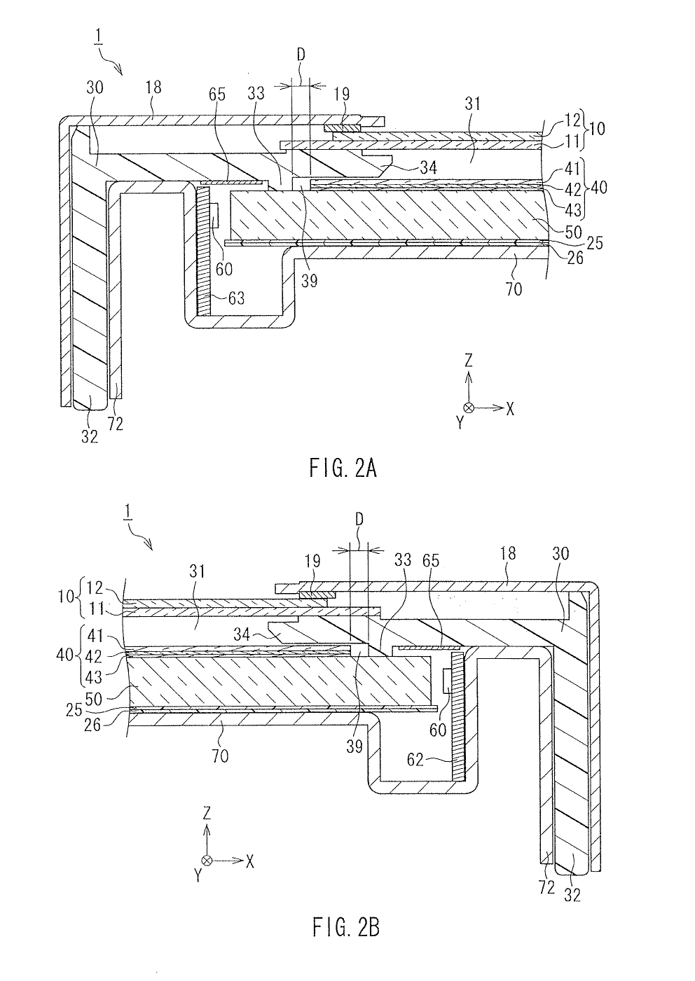

FIG. 2A is a cross-sectional view taken along a plane parallel to the XZ plane and showing the short side of the liquid crystal display device 1 of Embodiment 1, where the LED substrate 63 is located. FIG. 2B is a cross-sectional view taken along a plane parallel to the XZ plane and showing the short side of the liquid crystal display device 1 of Embodiment 1, where the LED substrate 62 is located.

As shown in FIGS. 2A and 2B, the reflecting sheet 26, 25, the light guide plate 50, and three optical sheets 40 (i.e., the diffusion sheet 43, the lens sheet 42, and the brightness enhancement sheet 41) are disposed in this order on the back plate 70. On top of this, the chassis 30 is further placed. A ridge-like protrusion 33 that protrudes toward the light guide plate 50 is formed on the surface of the chassis 30 that faces the light guide plate 50. The protrusion 33 extends substantially parallel to the end faces around the light guide plate 50. When the chassis 30 and the back plate 70 are fitted together so that side plates 32 around the chassis 30 cover side plates 72 around the back plate 70, the protrusion 33 is pressed against the upper surface of the light guide plate 50. Consequently, the light guide plate 50 and the reflecting sheets 25, 26 are sandwiched and fixed between the back plate 70 and the protrusion 33 of the chassis 30 in the Z axis direction.

The chassis 30 has a frame plate 34 in the form of a rectangular frame. The frame plate 34 is located inside (i.e., closer to the opening 31 than) the protrusion 33 and is parallel to the XY plane. The frame plate 34 and the light guide plate 50 are spaced in the Z axis direction, and the outer edges of the three optical sheets 40 are positioned in a space 39 between them. The size of the space 39 in the Z axis direction is slightly larger than the total thickness of the three optical sheets 40. Therefore, the edges of the three optical sheets 40 are not constrained by the light guide plate 50 and the frame plate 34. Moreover, the edges of the three optical sheets 40 are not in contact with the protrusion 33. The distance D between the edges of the three optical sheets 40 and the protrusion 33 is determined by taking into account the dimensional changes of the three optical sheets 40 due to environmental changes such as temperature and humidity. In FIGS. 2A and 2B, the distance D is the same for each of the three optical sheets 40. However, the distance D may differ from one optical sheet to another.

The liquid crystal panel 10 is placed on the frame plate 34 of the chassis 30, the bezel 18 is put over the liquid crystal panel 10, and then the bezel 18 and the chassis 30 are fitted together. The liquid crystal panel 10 is held between the frame plate 34 and the bezel 18 via a cushioning material 19 made of polyurethane or the like. In FIGS. 2A and 2B, the reference numeral 11 represents the active substrate and the reference numeral 12 represents the counter substrate. The reference numeral 65 represents a reflecting tape having a reflecting surface that reflects light from the light sources 60 toward the end faces of the light guide plate 50.

FIGS. 2A and 2B show the cross-sectional structures on the short sides of the liquid crystal display device 1. However, the cross-sectional structure on the long side where the LED substrate 61 is located is substantially the same as those shown in FIGS. 2A and 2B. The cross-sectional structure on the long side where the LED substrate 61 is not located is also substantially the same as those shown in FIGS. 2A and 2B except for the absence of the LED substrate.

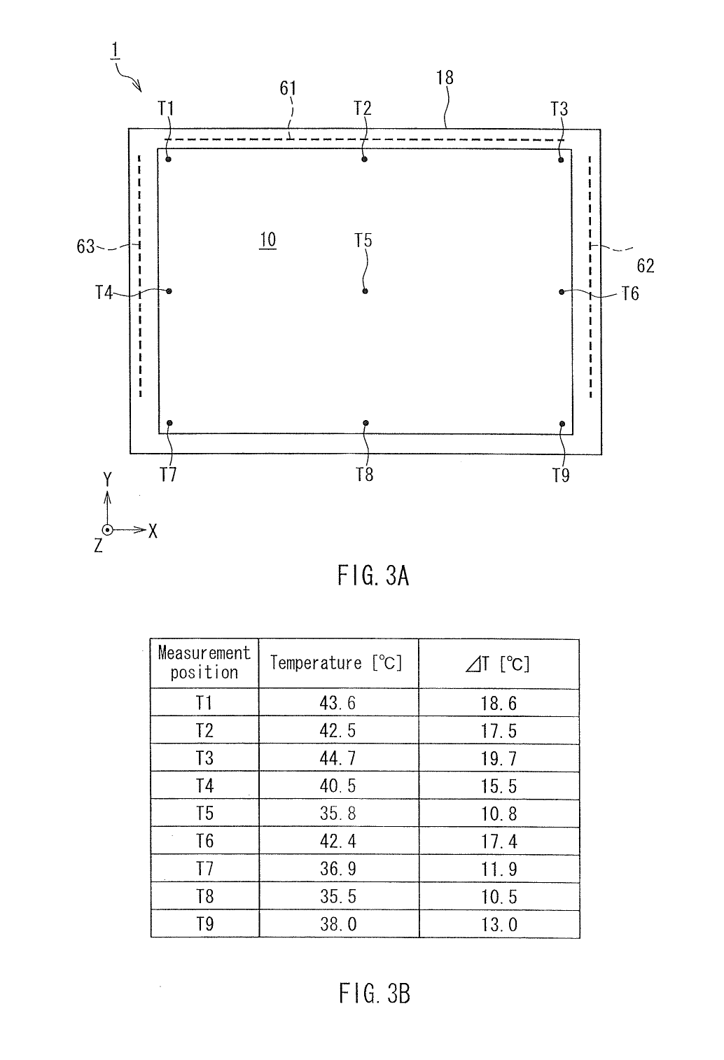

The liquid crystal display device 1 of this embodiment, in which the diagonal size is 23.1 inches and the aspect ratio of the display screen is 4:3, was displayed in an atmosphere of 25° C., and the surface temperature of the liquid crystal panel 10 was measured. FIG. 3A shows measurement positions T1 to T9, and FIG. 3B shows the results of the temperature measurement at each of the measurement positions. In FIG. 3B, “ΔT” represents a rise in temperature relative to the ambient temperature (25° C.).

As can be seen from FIG. 3B, the temperature rise is large at the measurement positions T1 to T4 and T6 in the vicinity of the LED substrates 61, 62, 63. Above all, the temperature rise is particularly large at the measurement position T3 in the vicinity of the corner portion that is sandwiched between two adjacent sides where the LED substrate 61 and the LED substrate 62 are located, and at the measurement position T1 in the vicinity of the corner portion that is sandwiched between two adjacent sides where the LED substrate 61 and the LED substrate 63 are located. This may be because the density of the arrangement of the LEDs 60 (heat generating elements) is relatively high in the corner portion that is sandwiched between two adjacent sides where the LED substrates are located (hereinafter, this corner portion is referred to as a “corner portion sandwiched between the LED substrates”). On the other hand, the temperature rise at the measurement position T8 in the vicinity of the long side where the LED substrates 61, 62, 63 are not located is the smallest of all the measurement positions.

It is assumed that the temperature distribution similar to that on the surface of the liquid crystal panel 10 as described above also occurs inside the liquid crystal display device 1, particularly inside the illuminating device 20. Among the constituent members of the illuminating device 20, the optical sheet 40 is often made of a material with a large linear expansion coefficient, compared to the other members. Therefore, the thermal expansion of the optical sheet 40 is larger on the sides along the LED substrates 61, 62, 63 than on the other side. Thus, the amount of the movement of the edge due to the thermal expansion is particularly large in the corner portion sandwiched between the LED substrates. Consequently, the edge of the thermally expanded optical sheet 40 may collide with the protrusion 33 (see FIGS. 2A and 2B) of the chassis 30, and eventually the optical sheet 40 may be curved in a wavelike fashion.

In order to suppress the local temperature rise in the vicinity of the corner portion sandwiched between the LED substrates, the arrangement pitch of the LEDs 60 on the LED substrates 61, 62, 63 can be made relatively large in the vicinity of the corner portion. However, if the arrangement pitch of the LEDs 60 is increased, a difference in brightness between the region closer to the LEDs 60 and the region farther from the LEDs 60 becomes large, and thus the brightness becomes non-uniform when the illuminating device 20 is viewed along the direction parallel to the Z axis, resulting in poor display quality of the liquid crystal display device 1.

Moreover, in order to prevent the edge of the thermally expanded optical sheet 40 from colliding with the protrusion 33 of the chassis 30, the protrusion 33 can be displaced away from the optical sheet 40 in the region in the vicinity of the corner portion where a possible collision may occur. However, in order to move the position at which the protrusion 33 is formed, a new mold is necessary to form the chassis 30, and thus the cost is increased. Moreover, additional time is required to produce the mold.

Therefore, in this embodiment, considering the amount of thermal expansion based on the uneven temperature rise during the operation, the shape of the optical sheet 40 is set to a pseudo-rectangle rather than a precise rectangle. This will be described in the following.

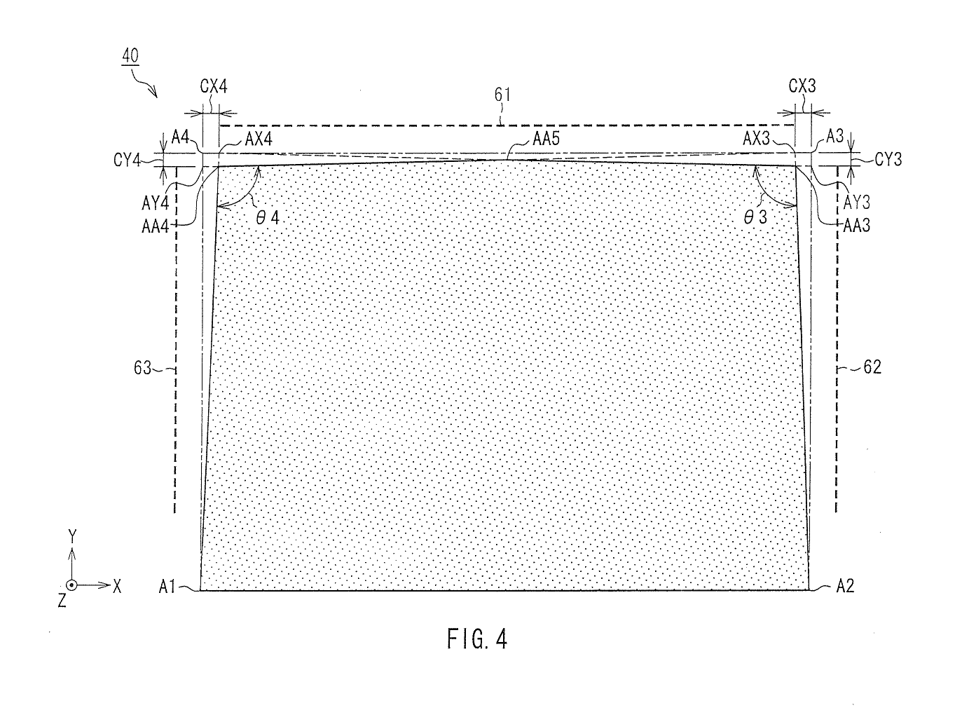

FIG. 4 shows a plan view of the optical sheet 40 of Embodiment 1. In FIG. 4, the alternate long and two short dashes line indicates a precise rectangle, and four vertices of the rectangle are represented by A1, A2, A3, and A4. The solid line indicates the outer shape of the optical sheet 40. For ease of understanding, the arrangement of the LED substrates 61, 62, 63 is represented by the broken lines. The LED substrate is not located on the side between the vertices A1, A2.

The outer shape of the optical sheet 40 is determined in the following manner. As shown in FIG. 4, AX3 represents a point that is shifted by a correction amount CX3 from the vertex A3 in the negative direction of the X axis, and AY3 represents a point that is shifted by a correction amount CY3 from the vertex A3 in the negative direction of the Y axis. Moreover, AX4 represents a point that is shifted by a correction amount CX4 from the vertex A4 in the positive direction of the X axis, and AY4 represents a point that is shifted by a correction amount CY4 from the vertex A4 in the negative direction of the Y axis. An intersection point of a line joining the vertex A2 and the point AX3 and a line joining the vertex A4 and the point AY3 is represented by a point AA3. An intersection point of a line joining the vertex A1 and the point AX4 and a line joining the vertex A3 and the point AY4 is represented by a point AA4. An intersection point of a line joining the vertex A3 and the point AY4 and a line joining the vertex A4 and the point AY3 is represented by a point AA5. The outer shape of the optical sheet 40 is defined by a line that joins the points A1, A2, AA3, AA5, and AA4 in sequence. The correction amounts CX3, CX4, CY3, and CY4 can be determined in view of the linear expansion coefficient of the optical sheet 40, the temperature distribution of the optical sheet 40 during the operation of the illuminating device 20, or the like.

As described above, in this embodiment, the outer shape of the optical sheet 40 is the pseudo-rectangle that is obtained by retreating the corner portions sandwiched between the LED substrates 61 and 62, 63 (i.e., the corner potions containing the vertices A3 and A4, respectively) of the four corner portions of the precise rectangle indicated by the alternate long and two short dashes line so that each of the interior angles θ3, θ4 of these corner portions is greater than 90 degrees. Thus, it is possible to avoid a collision between the edge of the optical sheet 40 and the protrusion 33 (see FIGS. 2A and 2B) of the chassis 30 in the corner portion sandwiched between the LED substrates due to the uneven temperature rise of the optical sheet 40 during the operation of the illuminating device 20. Moreover, it is relatively easy to change the outer shape of the optical sheet 40 from the precise rectangle to the pseudo-rectangle, and such a change requires only a small cost.

### Embodiment 2

In Embodiment 1, the LED substrates 61, 62, 63 are located opposite three end faces of the four end faces of the light guide plate 50 and arranged into a substantially U-shape. In Embodiment 2, the LED substrate 63 is omitted, and the LED substrates 61, 62 are located opposite two adjacent end faces of the liquid guide plate 50 and arranged into a substantially L-shape. An edge tape may be attached to the end face of the light guide plate 50 where the LED substrate 63 has been removed so as to allow the light that has leaked from this end face to the outside to reenter the light quid plate 50.

The temperature distribution during the operation of the illuminating device 20 differs from Embodiment 1 because of the removal of the LED substrate 63, and the temperature is the highest in the corner portion sandwiched between the LED substrates 61, 62 and is the lowest in the corner portion that is opposite this corner portion. The outer shape of the optical sheet 40 constituting the illuminating device 20 of this embodiment is set to a pseudo-rectangle in accordance with the above temperature distribution. This will be described in the following.

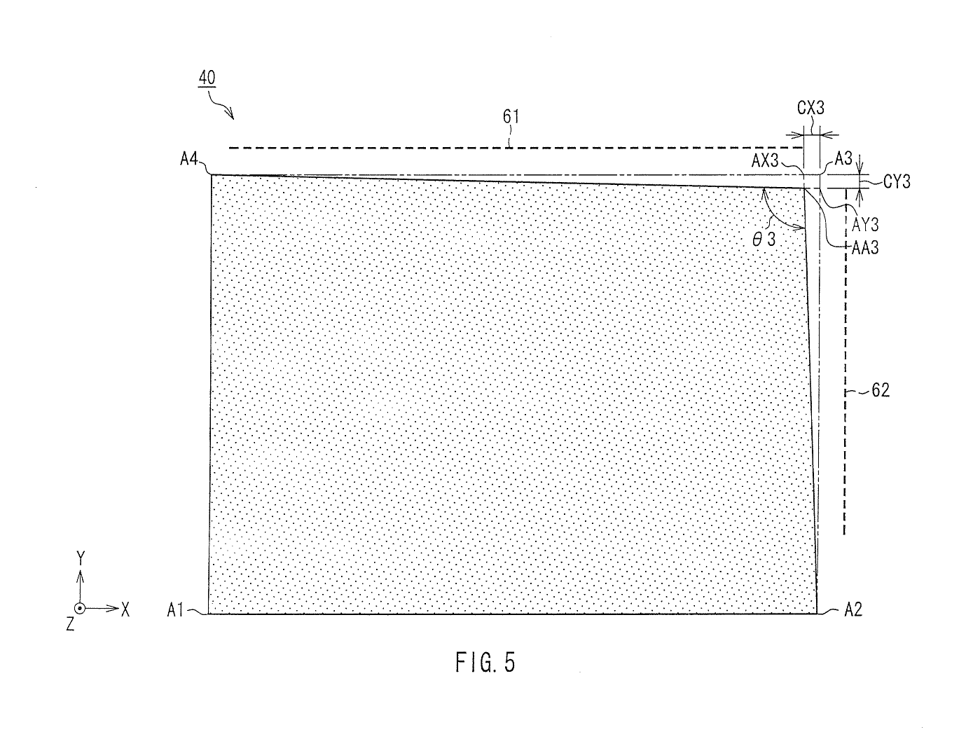

FIG. 5 shows a plan view of the optical sheet 40 of Embodiment 2. In FIG. 5, the alternate long and two short dashes line indicates a precise rectangle, and four vertices of the rectangle are represented by A1, A2, A3, and A4. The solid line indicates the outer shape of the optical sheet 40. For ease of understanding, the arrangement of the LED substrates 61, 62, is represented by the broken lines. The LED substrate is not located on the side between the vertices A1, A2 and the side between the vertices A1, A4.

The outer shape of the optical sheet 40 is determined in the following manner. As shown in FIG. 5, AX3 represents a point that is shifted by a correction amount CX3 from the vertex A3 in the negative direction of the X axis, and AY3 represents a point that is shifted by a correction amount CY3 from the vertex A3 in the negative direction of the Y axis. An intersection point of a line joining the vertex A2 and the point AX3 and a line joining the vertex A4 and the point AY3 is represented by a point AA3. The outer shape of the optical sheet 40 is defined by a line that joins the points A1, A2, AA3, and A4 in sequence. The correction amounts CX3 and CY3 can be determined in view of the linear expansion coefficient of the optical sheet 40, the temperature distribution of the optical sheet 40 during the operation of the illuminating device 20, or the like.

As described above, in this embodiment, the outer shape of the optical sheet 40 is the pseudo-rectangle that is obtained by retreating the corner portion sandwiched between the LED substrates 61, 62 (i.e., the corner portion containing the vertex A3) of the four corner portions of the precise rectangle indicated by the alternate long and two short dashes line so that the interior angle 03 of this corner portion is greater than 90 degrees. Thus, like Embodiment 1, it is possible to avoid a collision between the edge of the optical sheet 40 and the protrusion 33 (see FIGS. 2A and 2B) of the chassis 30 in the corner portion sandwiched between the LED substrates due to the uneven temperature rise of the optical sheet 40 during the operation of the illuminating device 20.

The liquid crystal display device and the illuminating device of Embodiment 2 are the same as those of Embodiment 1 except for the above configuration.

It should be noted that Embodiments 1, 2 are merely illustrative, and the present invention is not limited to these embodiments and can be appropriately changed.

The arrangement of the light source is not limited to Embodiment 1 in which the light sources are arranged into a substantially U-shape along three end faces of the four end faces around the substantially rectangular light guide plate 50, and Embodiment 2 in which the light sources are arranged into a substantially L-shape along two end faces of the four end faces around the substantially rectangular light guide plate 50. For example, the light sources may be arranged into a substantially hollow square (substantially rectangle) along all the four end faces around the substantially rectangular light guide plate 50. In this case, the outer shape of the optical sheet 40 can be a pseudo-rectangle (octagon) that is obtained by retreating all the four corner portions of the precise rectangle so that each of the interior angles is greater than 90 degrees.

In Embodiments 1, 2, the LED 60 is used as a light source. However, the light source of the present invention is not limited thereto, and any light sources such as discharge fluorescent tubes (a cold-cathode fluorescent tube, a hot-cathode fluorescent tube, a xenon fluorescent tube, etc.) and an EL cell can be used. The amount of heat generated by the light source varies depending on the type of the light source. Moreover, the heat generating portion also varies depending on the type of the light source. For example, in the case of a cold-cathode fluorescent tube, the temperature is the highest in the vicinity of the electrode portions at both ends of the cold-cathode fluorescent tube. Therefore, it is preferable that the outer shape of the optical sheet is appropriately changed in accordance with the type of the light source.

In Embodiment 1, 2, the optical sheet 40 includes three sheets of the brightness enhancement sheet 41, the lens sheet 42, and the diffusion sheet 43. However, the optical sheet of the present invention is not limited thereto, and any sheets used for the illuminating device can be used. The functions of the optical sheet are not limited to those described in the above embodiments. Moreover, the material, number, or the like of the optical sheet also are not limited to those described in the above embodiments.

In Embodiment 1, 2, the outer shapes of all the optical sheets are pseudo-rectangles as shown in FIGS. 4 and 5. However, the present invention is not limited thereto. If a plurality of optical sheets are provided, only part of the optical sheets may be in the form of a pseudo-rectangle. In particular, it is preferable that the optical sheet having a relatively large linear expansion coefficient should be preferentially in the form of a pseudo-rectangle. Moreover, the correction amounts for the vertices of the precise rectangle (i.e., the correction amounts CX3, CX4, CY3, and CY4) may differ from one optical sheet to another in accordance with the linear expansion coefficient or the like of the optical sheet.

In order to position the optical sheet with respect to the peripheral member such as the back plate 70, projections or notches may be formed in the edge around the optical sheet.

A part or the whole of the outer shapes of the light guide plate 50 and the reflecting sheets 25, 26 other than the optical sheet may be the pseudo-rectangle similar to that of the optical sheet.

The illuminating device of the present invention also can be used in applications other than the backlight device of the transmission type liquid crystal display device as described in Embodiments 1, 2. For example, the illuminating device can be applied to a film viewer for irradiating x-ray radiographs with light, a light box for irradiating negatives or the like with light to ensure better viewability, or an illuminating device for illuminating various signboards, advertisements, guide signs, etc. placed indoors or outdoors. The configuration of each portion of the illuminating device can be appropriately changed in accordance with the application of the illuminating device.

The display device of the present may include the illuminating device of the present invention, and also can be any display device that requires illumination light. The display device may display either dynamic images or static images.

All of the above-described embodiments are strictly intended to clarify the technical contents of the present invention. The present invention should not be interpreted as being limited to such specific examples, but should be broadly interpreted, and various modifications of the invention can be made within the spirit and scope of the invention as set forth in the appended claims.

### INDUSTRIAL APPLICABILITY

The field of industrial application of the present invention is not particularly limited, and the present invention can be suitably used particularly for a transmission type or semi-transmission type display panel.

1. An illuminating device comprising:
a light guide plate that includes a substantially rectangular light emission surface and four end faces adjacent to the light emission surface;
a light source that is located opposite at least two adjacent end faces of the four end faces of the light guide plate; and
a chassis that has an opening through which light emanating from the light emission surface of the light guide plate passes,
wherein at least one optical sheet that includes a corner portion with an interior angle of greater than 90 degrees in a position corresponding to a corner portion of the light guide plate that is sandwiched between the two end faces opposite the light source is disposed between the light emission surface and the chassis.

2. The illuminating device according to claim 1, wherein the at least one optical sheet including the corner portion with an interior angle of greater than 90 degrees has a linear expansion coefficient of 7×10⁻⁵/K or more.

3. The illuminating device according to claim 1, wherein the light source is an LED.

4. The illuminating device according to claim 1, wherein the light source is located opposite three end faces of the four end faces of the light guide plate.

5. The illuminating device according to claim 1, wherein the light source is located opposite two end faces of the four end faces of the light guide plate.

6. A display device comprising the illuminating device according to claim 1.
